(19) United States
(12) Patent Application Publication
(10) Pub. No.: US 2023/0350017 A1
(43) Pub. Date: Nov. 2, 2023

(54) POWER CONTROL FOR WIRELESS SENSING

(71) Applicant: QUALCOMM Incorporated, San Diego, CA (US)

(72) Inventors: Jing DAI, Beijing (CN); Yuwei REN, Beijing (CN); Hao XU, Beijing (CN)

(21) Appl. No.: 17/914,243

(22) PCT Filed: Jun. 1, 2020
(86) PCT No.: PCT/CN2020/093661

§ 371 Date: Sep. 23, 2022

(51) Int. Cl. G01S 7/40; G01S 7/02; G01S 7/00; H04W 52/24; H04W 76/10

(52) U.S. Cl. CPC G01S 7/4013; G01S 7/023; G01S 7/006; H04W 52/245; H04W 52/243; H04W 76/10

(57) ABSTRACT

A user equipment (UE) and base station may be configured to implement power control for wireless sensing. In some aspects, the UE may connect to a base station via a radio access technology (RAT), receive sensing information including a power level selected by the base station to limit interference during a wireless sensing event using the RAT, and perform the wireless sensing event based on the power level via the RAT.

### BACKGROUND

### Technical Field

The present disclosure relates generally to communication systems, and more particularly to wireless devices configured to implement power control for wireless sensing.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure provides a method of wireless communication at a user equipment (UE). The method may include connecting to a base station via a radio access technology (RAT), receiving sensing information from the base station, the sensing information including a power level selected by the base station to limit interference during a wireless sensing event using the RAT, and performing, via the RAT, the wireless sensing event based on the power level.

In an aspect, the disclosure provides a method of wireless communication at a base station. The method may include establishing a connection with a UE via a RAT, determining sensing information for a wireless sensing event to be performed by the UE via the RAT, the sensing information to be used for power control of the UE during the wireless sensing event, and sending the sensing information to the UE.

In an aspect, the disclosure provides a method of wireless communication at a base station. The method may include performing, via a transmitter, a first wireless sensing event, receiving interference information from one or more adjacent wireless devices connected to a radio access network (RAN), the interference information including interference measurements captured by the one or more adjacent wireless devices in response to the first wireless sensing event, determining a power level based on the interference information, the power level decreasing interference at the one or more adjacent wireless devices, and performing, via the transmitter at the power level, a second wireless sensing event.

The disclosure also provides an apparatus (e.g., a user equipment (UE), a base station) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least the above methods.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first 5G/NR frame.

FIG. 2B is a diagram illustrating an example of DL channels within a 5G/NR subframe.

FIG. 2C is a diagram illustrating an example of a second 5G/NR frame.

FIG. 2D is a diagram illustrating an example of UL channels within a 5G/NR subframe.

FIG. 3 is a diagram illustrating an example of a base station and UE in an access network.

FIG. 4 is a diagram illustrating example communications and components of base stations and UEs.

FIG. 5 is a diagram illustrating an example of a hardware implementation for a UE employing a processing system.

FIG. 6 is a diagram illustrating an example of a hardware implementation for a base station employing a processing system.

FIG. 7 is a flowchart of a first method of wireless communication by a UE.

FIG. 8 is a flowchart of a second method of wireless communication by a base station.

FIG. 9 is a flowchart of a third method of wireless communication by a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Recent advances in wireless communication have introduced wireless communication systems utilizing radio access technologies operating in higher frequencies (e.g., mmWave, Tetrahertz (THz), low THz band, 30-300 GHz frequency range, etc.). In addition to providing high-rate communications, wireless components configured to operate in higher frequencies may also provide high-resolution sensing capabilities. But employing a communication component for wireless sensing within a communication system may interfere with data transmissions at other wireless devices within the communication system. For example, radar signals transmitted during wireless sensing activity by a user equipment may interfere with wireless communications to and from adjacent user equipment devices. As used herein, “wireless sensing” may refer to employing reflected waveforms and signal processing to detect, predict, or measure. In some aspects, a machine learning system may also be employed in a wireless sensing technique. For example, the raw data corresponding to the reflected signal may be converted into a fast fourier transform (FFT). In addition, one or more regression techniques, classification techniques, or other artificial intelligence techniques may be applied to the FFT to perform a wireless sensing action.

The present disclosure addresses the above-described interference issue by providing, in one aspect, a sensing management procedure where a UE connects to a base station via a RAT, receives sensing information from the base station, the sensing information including a power level selected by the base station to limit interference during a wireless sensing event using the RAT, and performs, via the RAT, the wireless sensing event based on the power level. By receiving sensing information from the base station to utilize in a power control operation with the transmitter, the present solution leverages high-rate wireless components for high-resolution sensing while limiting interference caused by the wireless components during wireless sensing activity.

Thus, the present aspects may improve network communications and expand wireless device capabilities by coordinating wireless sensing activities performed by communication devices within a communication system, thereby limiting interference caused by collisions between wireless sensing signals and communication signals.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

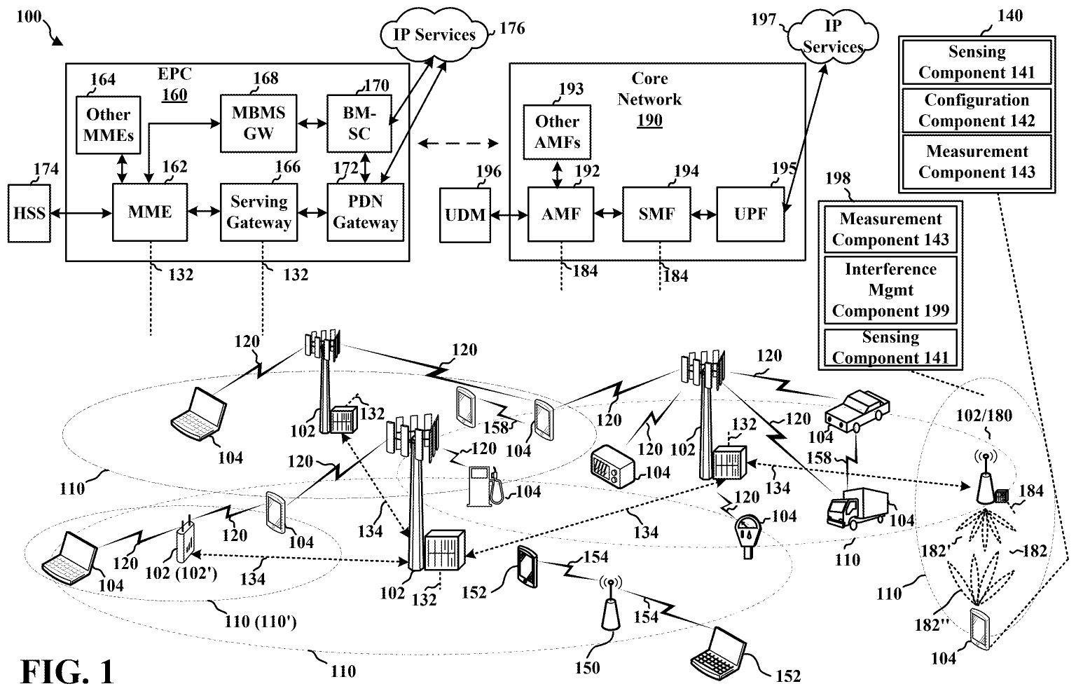

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. In an aspect, a UE 104 may include sensing management component 140 that is configured to manage wireless sensing activity performed by the UE 104. The sensing management component 140 may include a sensing component 141 configured to perform wireless sensing operations, a configuration component 142 configured to provide sensing parameters to the sensing components 141 for performing wireless sensing operations, and a measurement component 143 configured to measure signal strength of wireless devices at the UE 104. Further, in some aspects, a base station 102 may include a sensing management component 198 configured to manage wireless sensing activity performed by wireless devices within a wireless communication system. The sensing management component 198 may include an interference management component 199 configured to determine sensing parameters for wireless sensing operations performed within a wireless communication system, a sensing component 141 configured to perform wireless sensing operations, and a measurement component 143 configured to determined signal information for wireless devices within the communication system. As described in detail herein, the sensing parameters may be utilized to reduce, minimize, or prevent interference between wireless sensing activity and data transmissions.

In some aspects, the wireless sensing activity may include transmitting wideband radar signals with a pre-defined waveform and detecting reflected signals corresponding to the radar signals. Further, the reflected signals may be processed according to different wireless sensing applications. The radar signals may be chirp waveforms or OFDM waveforms. Further, some applications for the wireless sensing activity include motion detection, object identification, user interface applications, facial recognition, user activity detection, UE context detection, health monitoring, environment imaging, communication assistance (e.g., accurate beam tracking), side-link based sensing (e.g., vehicle sensing in V2X), and Wi-Fi sensing (e.g., location detection, room mapping, etc.). Further, wireless sensing at the higher frequencies described herein may provide high bandwidth and large aperture from which to extract accurate range information, doppler information, or angular information. Some benefits of wireless sensing at higher frequencies may include touchless interaction, ease of incorporation into UEs having a small form factor, low power consumption, and non-vision based context awareness or sensing (e.g., no line of sight (NLOS) context awareness).

The base stations 102 configured for 4G LTE (collectively referred to as

Evolved Universal Mobile Telecommunications System (UMTS) Terrestrial Radio Access Network (E-UTRAN)) may interface with the EPC 160 through first backhaul links 132 (e.g., 51 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as THz, and other wireless technologies.

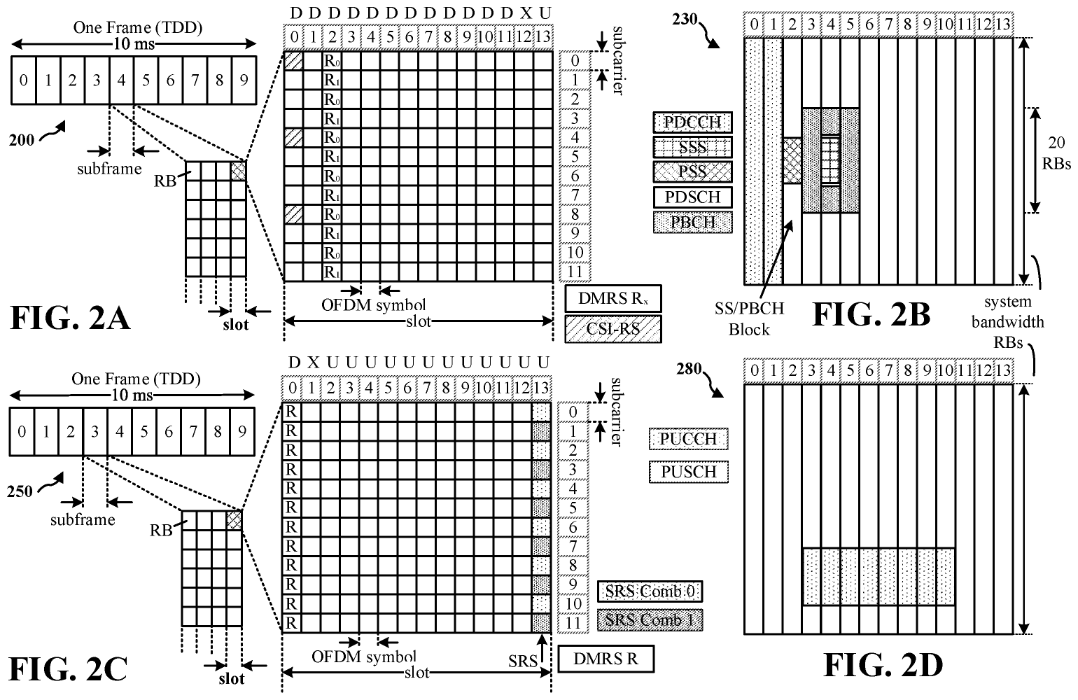

FIGS. 2A-2D illustrates example diagrams 200, 230, 250, and 280 illustrating examples structures that may be used for wireless communication by the base station 102 and the UE 104, e.g., for 5G NR communication. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

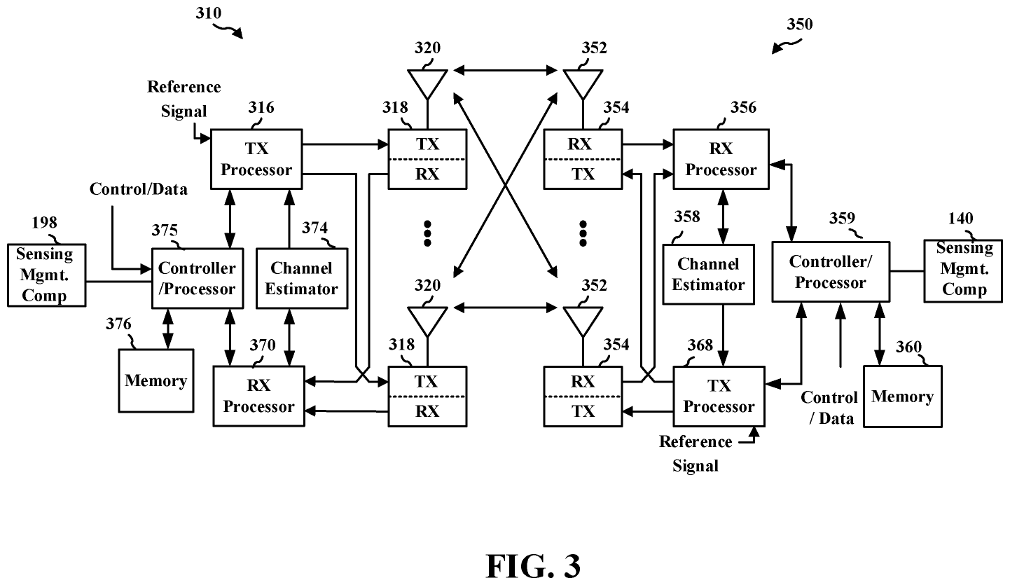

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with sensing management component 140 of FIG. 1.

At least one of the TX processor 316, the RX processor 370, and the controller/processor 375 may be configured to perform aspects in connection with sensing management component 198 of FIG. 1.

As described herein, a wireless communication system may enable wireless communication devices to employ high-frequency RAT, e.g., mmWave or THz, for wireless sensing and data transmission. In order for high-resolution wireless sensing and high-throughput data transmission to efficiently co-exist within a communication system, UEs and base stations may implement power control for wireless sensing. In particular, techniques for power control for wireless sensing minimize interference between data transmission operations and wireless sensing operations by employing power levels for wireless sensing activities that reduce, minimize, or prevent collision with other operations within the communication system.

The present disclosure provides techniques for power control for wireless sensing. As used herein, “power control” may refer to the selection of transmitter power output in a communication system. For example, a UE and base station can perform a sensing management technique that implements power control for wireless sensing based on the UE employing sensing information received from the base station. In some aspects, the base station may send the UE a power level for performing a wireless sensing activity, a range of power levels for performing the wireless sensing activity, a maximum power level for performing the wireless sensing activity, a sensing grant for performing a wireless sensing activity, or a reference power level for performing a wireless sensing activity. Further, the base station may determine the sensing information based upon uplink activity from another UE or measurement information corresponding to UE activity captured by adjacent devices. In some other aspects, a wireless device may perform a first wireless sensing event, collect interference information based upon the first wireless sensing event from adjacent devices, and determine a power level based on the interference information. Accordingly, the present techniques enable wireless devices in a communication system to perform wireless sensing using a power level determined to reduce, minimize, or prevent interference with adjacent wireless devices.

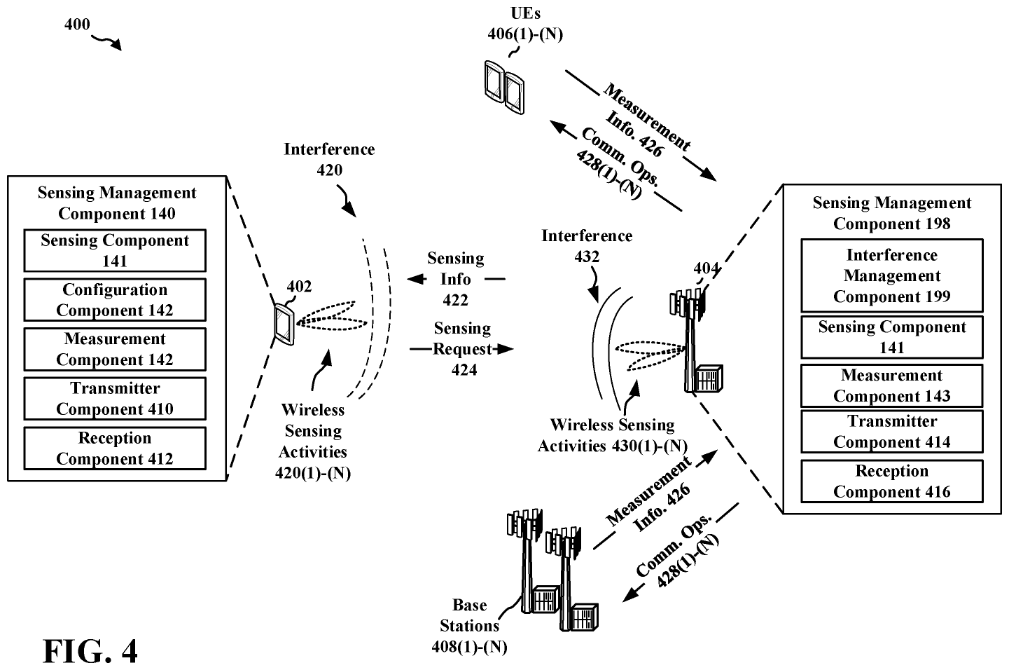

Referring to FIGS. 4-10, in one non limiting aspect, a system 400 is configured to provide power control for wireless sensing.

FIG. 4 is a diagram illustrating example communications and components of base stations and UEs. As illustrated in FIG. 4, the system 400 may include a UE 402 connected to a base station 404 via a RAT operating in a dual-use frequency band. As described herein, in some aspects, a “dual-use frequency band” may refer to a frequency band that may be employed for at least high-rate data communications and high-resolution sensing. Some examples of a dual use frequency band include mmWave and THz. In addition, the system 400 may include a plurality of UEs 406(1)-(N) and plurality of base stations 408(1)-(N). In some aspects, the plurality of UEs 406(1)-(N) and the plurality base stations 408(1)-(N) may be located in a similar location as the UE 402 and/or the base station 404, or operating on the same network as the UE 402 and/or the base station 404. Additionally, in some aspects, the base station 404 and the plurality of base stations 408(1)-(N) may be examples of a base station 102, and the UE 402 and the plurality of UEs 406(1)-(N) may be examples of a UE 104.

Further, the UE 402 may include the sensing management component 140. As described above with respect to FIG. 1, the sensing management component 140 may include the sensing component 141, the configuration component 142, and the measurement component 143. In addition, the UE 402 may include the reception component 412 and the transmitter component 410. The reception component 412 may include, for example, a radio frequency (RF) receiver for receiving the signals described herein (e.g., the reflected radar signals). The transmitter component 410 may include, for example, an RF transmitter for transmitting the signals described herein. Further, the transmitter component 410 be configured to generate and transmit signals for sensing as described herein. In an aspect, the reception component 412 and the transmitter component 410 may be co-located in a transceiver (e.g., the transceiver 510).

Additionally, the base station 402 may include the sensing management component 198. As described above with respect to FIG. 1, the sensing management component 198 may include the interference management component 199, the sensing component 141, and the measurement component 143. In addition, the base station 404 may include the reception component 416 and the transmitter component 414. Further, the transmitter component 410 be configured to generate signals for sensing as described herein. The reception component 416 may include, for example, a radio frequency (RF) receiver for receiving the signals described herein. The transmitter component 414 may include, for example, an RF transmitter for transmitting the signals described herein. Further, the transmitter component 410 be configured to generate signals for sensing as described herein. In an aspect, the reception component 416 and the transmitter component 414 may be co-located in a transceiver (e.g., the transceiver 610).

As illustrated in FIG. 4, the UE 402 may endeavor to perform one or more wireless sensing activities 418. Further, due to a common location of the UE 402 and at least one of the base station 404, the plurality of UEs 406(1)-(N), or the plurality of base stations 408(1)-(N), the wireless sensing activities 418 may interfere with communications between the base station 404, the plurality of UEs 406(1)-(N), and/or the other base stations 408(1)-(N). For example, the wireless sensing activities 418(1)-(N) by the UE 402 may interfere with communication activity at the UE 406(1) based at least in part on the proximity between the UE 402 and the UE 406(1). As such, the UE 402, the base station 404, the plurality of UEs 406(1)-(N), and/or the plurality of base stations 408(1)-(N) may employ sensing management techniques to reduce, prevent or minimize interference 420 caused by the wireless sensing activities 418. It is noted that the interference 420 is illustrated in dashed line format to represent this interference being optional, as this interference may not occur based on the features described herein for reducing or avoiding interference.

For example, as illustrated in FIG. 4, the sensing management component 198 of the base station 404 may send the sensing information 422 to the UE 402. Upon receipt of the sensing information 422, the sensing management component 140 may cause the UE 402 to perform wireless sensing activities 418 in accordance with the sensing information 422 to reduce, minimize, or prevent the interference 420.

In some aspects, the sensing information 422 may include a maximum power level. Further, the sensing management component 140 may perform the wireless sensing activity 418 via the transmitter component 410 with a power value less than or equal to the maximum power value of the sensing information 422. In some other aspects, the sensing management component 140 may determine whether an application of the wireless sensing activity 418 is a high priority application. Further, if the application is a high priority application, the sensing management component 140 may override the maximum power level, and perform the wireless sensing activity 418 via the transmitter component 410 with a power level greater than the maximum power level of the sensing information 422.

In some aspects, the sensing information 422 may include a plurality of maximum power levels. Further, each maximum power level may be associated with a particular context. Further, the sensing management component 140 may identify a context of the wireless sensing activity 418, and perform the wireless sensing activity with a power level lesser than or equal to the particular maximum power level associated with the context as defined in the sensing information 422. In some other aspects, the sensing information 422 may include a reference value. Further, upon receipt of the reference level, the sensing management component 140 may use the reference level to determine the actual power level to use when performing the wireless sensing activity 418. For instance, the reference value may indicate that the actual power level should be a percentage of a pre-configured or previously assigned value (e.g., 60% of the power level used for an uplink sounding reference signal (SRS)). In some aspects, the reference level may be a recommendation and the sensing management component 140 may employ a different value based upon one or more other factors (e.g., previous sensing activity, a context of the wireless sensing activity, etc.).

As illustrated in FIG. 4, in some aspects, the sensing management component 140 may send a sensing request 424 to the base station 404 requesting the sensing information 422. In some aspects, the sensing request 424 may include at least one of the following: a request for a power level for a wireless sensing activity, a proposed power level for the wireless sensing activity, or a context identifier identifying an application of the wireless sensing activity 418. Further, in some aspects, in response to the sensing request 424, the base station 404 may send the sensing information 422 including at least one of a power level, maximum power level, a power level range, an approval of a proposed power level, a denial of a sensing request or proposed power level, a sensing grant identifying resource information, and/or a power level for performing the wireless sensing activity 418. In some aspects, the resource information may include timing information for performing the wireless sensing activity 418, frequency information for performing the wireless sensing activity 418, a power indication identifying a power level for performing the wireless sensing activity 418. In response to denial of a sensing request or a proposed power level (e.g., the sensing information 422 may include a rejection communication), the base station 404 may send a second proposed power level, or the UE 402 may send a second sensing request or a second proposed power level for consideration by the base station 404.

Further, as illustrated in FIG. 4, the UE 402, the plurality of UEs 406(1)-(N), and the plurality of base stations 408(1)-(N) may send the measurement information 426 to the base station 404. In some aspects, the measurement information 426 may include signal strength information determined by the adjacent wireless devices (e.g., a received signal strength indicator (RSSI)). In addition, the UE 402, the plurality of UEs 406(1)-(N), and the plurality of base stations 408(1)-(N) may perform a plurality of communication operations 428 (e.g., transmissions and receptions) with the base station 404. Further, the sensing management component 198 may determine the sensing information 422 based at least in part on the measurement information 426 and the communication operations 428. For example, the base station 404 may determine a maximum power level or resource information for the wireless sensing activity 418 based at least in part on leveraging the measurement information 426 and the communication operations 428 to reduce, minimize, or prevent the interference 420 at one or more of the base station 404, the plurality of UEs 406(1)-(N), and/or the plurality of base stations 408(1)-(N) during performance of the wireless sensing activity 418(1).

In some aspects, the system 400 may implement a closed-loop power control approach for interference management of wireless sensing activity 418 performed by the UE 402 or the base station 404. As used herein, a “close-loop power control” may refer to a power control technique based on feedback from another device. For example, as illustrated in FIG. 4, the base station 404 may endeavor to perform one or more wireless sensing activities 430(1)-(N). Further, due to a common location of the base station 404 and at least one of the UE 402, the plurality of UEs 406(1)-(N), or the plurality of base stations 408(1)-(N), the wireless sensing activities 430(1)-(N) may interfere with communications between the UE 402, the base station 404, the plurality of UEs 406(1)-(N), and the other base stations 408(1)-(N). For example, the wireless sensing activities 430(1)-(N) by the base station 404 may interfere with communication activity at the UE 406(1) based at least in part on the proximity between the base station 404 and the UE 406(1).

In some aspects, the base station 404 may perform a first wireless sensing activity 430(1) to cause the interference 432. In addition, the base station 404 may receive measurement information 426 from the plurality of UEs 406(1)-(N) and the plurality of base stations 408(1)-(N) corresponding to the interference 432. In some aspects, the measurement information 426 may include measurement of the interference 432 at the plurality of UEs 406(1)-(N) and the plurality of base stations 408(1)-(N). Further, the base station 404 may employ the sensing management component 198 to determine a power level for subsequent wireless sensing activities 430(2)-(N) based on the measurement information 426. In particular, the sensing management component 198 may identify the devices that detected the interference 432, and determine a power level that reduces, minimizes, or prevents subsequent interference at the identified devices in response to the wireless sensing activities 430(2)-(N). For example, the sensing management component 198 may determine a power level that would cause interference measurements at the identified devices below a pre-configured threshold.

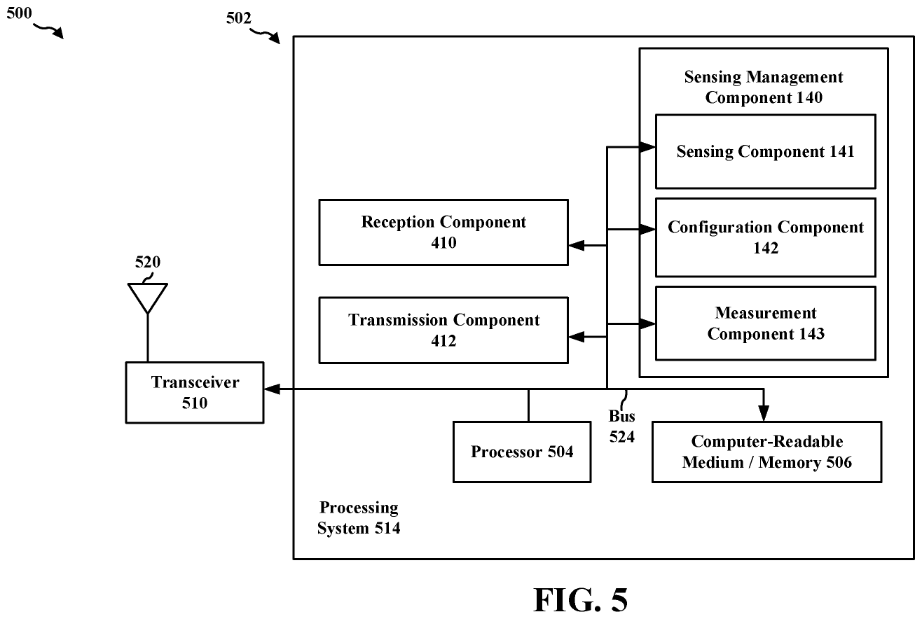

FIG. 5 is a diagram 500 illustrating an example of a hardware implementation for an UE 502 employing a processing system 514. The processing system 514 may be implemented with a bus architecture, represented generally by the bus 524. The bus 524 may include any number of interconnecting buses and/or bridges depending on the specific application of the processing system 514 and the overall design constraints. The bus 524 links together various circuits including one or more processors and/or hardware components, represented by the processor 504, the sensing management component 140, the sensing component 141, configuration component 142, measurement component 143, and the computer-readable medium (e.g., non-transitory computer-readable medium)/memory 506. The bus 524 may also link various other circuits such as timing sources, peripherals, voltage regulators, and power management circuits, which are well known in the art, and therefore, will not be described any further.

The processing system 514 may be coupled with a transceiver 510. The transceiver 510 may be coupled with one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 412. In addition, the transceiver 510 receives information from the processing system 514, specifically the transmitter component 410, and based on the received information, generates a signal to be applied to the one or more antennas 520. The processing system 514 includes a processor 504 coupled to a computer-readable medium / memory 506. The processor 504 is responsible for general processing, including the execution of software stored on the computer-readable medium / memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes at least one of the sensing management component 140, the sensing component 141, the configuration component 142, or the measurement component 143. The components may be software components running in the processor 504, resident/stored in the computer readable medium/memory 506, one or more hardware components coupled to the processor 504, or some combination thereof. The processing system 514 may be a component of the UE 350 and may include the memory 360 and/or at least one of the TX processor 368, the RX processor 356, and the controller/processor 359. Alternatively, the processing system 514 may be the entire UE (e.g., see 350 of FIG. 3).

The sensing component 141 may be configured to perform wireless sensing activities (e.g., the wireless sensing activities 420(1)-(N)) using the transmitter component 410 and the reception component 412. In some aspects, the sensing component 141 may direct the transmitter component 410 to transmit radar signals with a pre-defined waveform (e.g., frequency-modulated continuous-wave (FMCW) radar, pulse radar, etc.) and receive reflected signals corresponding to the radar signals via the reception component 412. In addition, the sensing component 141 may perform radar signal processing using the radar signals and the reflected signals to determine processing information, e.g., the sensing component 141 may correlate the reflected signals to the originally-transmitted radar signals. In some aspects, correlating the transmitted radar signals and the reflected signals may include comparing differences in amplitude and identifying time shift information. Further, the processing information may be used to make a sensing determination. For instance, the sensing component 141 may apply machine learning techniques to the correlation information to classify an event or an object, or predict an outcome. In some aspects, the sensing component 141 may be used to generate an image of an environment, determine high resolution localization information, facilitate establishing or adjusting a beamformed communication link, or detect human activity (e.g., gestures, health activity, etc.).

The configuration component 142 may be configured to determine a power level of the transmitter component 410 and/or other resource information for wireless sensing activity (e.g., the wireless sensing activities 420(1)-(N)) performed by the sensing component 141. In some aspects, the configuration component 142 may receive the sensing information 422, and configure the wireless sensing activity 418 based upon the sensing information 422. For example, as described in detail herein, the configuration component 142 may determine the power level for the transmitter component 410 during a wireless sensing activity.

In some aspects, the configuration component 142 may determine the power level based on a context or priority of the wireless sensing activity 418. Additionally, or alternatively, the configuration component 142 may determine the power level based on a maximum power level or reference power level specified by the base station 404. In some other aspects, the configuration component 142 may determine the power level based on interference measurement determined by the measurement component 143. Further, the configuration component 142 may schedule a wireless sensing activity 418 based upon a sensing grant included in the sensing information 422. In addition, in some aspects, the configuration component 142 may be configured to send the sensing request 424 to the base station 404.

The measurement component 143 may be configured to determine measurements for performing interference management within the system 400. As an example, the measurement component 143 may be configured to determine signal strength measurements at the UE 502. In some aspects, the measurement component 143 may be configured to determine RSSI information of adjacent UEs (the plurality of UEs 406(1)-(N)). In addition, the measurement component 143 may be configured to determine an amount of interference caused by an wireless sensing activity performed by another device. In some aspects, the measurement component 143 may provide measurements made by the measurement component 143 to the configuration component 142, or other wireless devices as the measurement information 426 in order to assist in interference management.

In one configuration, the UE 502 for wireless communication includes means for connecting to a base station via a RAT, receiving sensing information from the base station, the sensing information including a power level selected by the base station to limit interference during a wireless sensing event using the RAT, and performing, via the RAT, the wireless sensing event based on the power level. The aforementioned means may be one or more of the aforementioned components of the UE 502 and/or the processing system 514 of the UE 502 configured to perform the functions recited by the aforementioned means. As described supra, the processing system 514 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

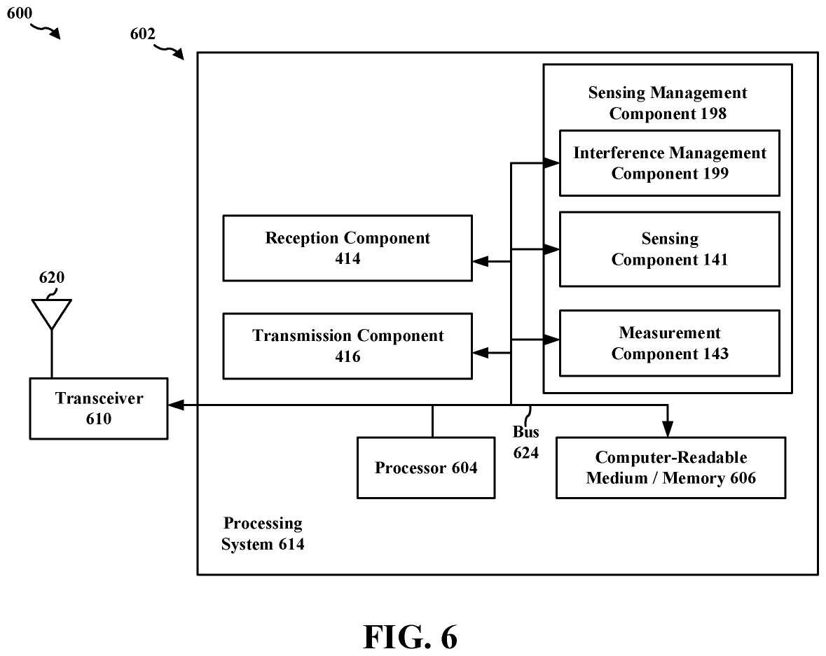

FIG. 6 is a diagram 600 illustrating an example of a hardware implementation for an base station 602 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware components, represented by the processor 604, the sensing management component 198, the interference management component 199, the sensing component 141, the measurement component 143, and the computer-readable medium/memory 606. The bus 624 may also link various other circuits such as timing sources, peripherals, voltage regulators, and power management circuits, which are well known in the art, and therefore, will not be described any further.

The processing system 614 may be coupled with a transceiver 610. The transceiver 610 may be coupled with one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the reception component 416. In addition, the transceiver 610 receives information from the processing system 614, specifically the transmitter component 414, and based on the received information, generates a signal to be applied to the one or more antennas 620. The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system 614 further includes at least one of the sensing management component 198, interference management component 199, sensing component 141, and a measurement component 143. The components may be software components running in the processor 604, resident/stored in the computer readable medium/memory 606, one or more hardware components coupled to the processor 604, or some combination thereof. The processing system 614 may be a component of the base station 310 and may include the memory 376 and/or at least one of the TX processor 316, the RX processor 370, and the controller/processor 375. Alternatively, the processing system 614 may be the entire base station (e.g., see 310 of FIG. 3).

The interference management component 199 may be configured to determine power levels for transmitter components within the system 400 (e.g., transmitter component 410 and transmitter component 414). In addition, the interference management component 199 may be configured to determine resource information for wireless sensing activity (e.g., the wireless sensing activities 418(1)-(N)) performed by the UE 402, wireless sensing activities 430(1)-(N) performed by the base station 602, etc.) within the system 400.

In some aspects, the interference management component 199 may determine the sensing information 422, and send the sensing information 422 to the UE 402. Further, the UE 404 may use the sensing information 422 to determine a power level of the transmitter component 410 when performing a wireless sensing activity 418. In some aspects, the interference management component 199 may receive a sensing request 424 from a UE (e.g., the UE 402), and send the sensing information 422 in response to the sensing request 424. Further, the interference management component 199 may determine the sensing information 422 based on the measurement information 426.

In some aspects, the interference management component 199 may determine the power level based on interference measurements determined by the measurement component 143 or the measurement information 426 received from the plurality of UEs 406 or the plurality of base stations 408. Further, the interference management component 199 may schedule the wireless sensing activities 418(1)-(N) and 430(1)-(N) based upon communication operations 428(1)-(N). In particular, the interference management component 199 provider resources to the UEs 402 and 406(1)-(N) as to avoid, minimize, or reduce interference.

The sensing component 141 may be configured to perform wireless sensing activities (e.g., the wireless sensing activities 430(1)-(N)) using the transmitter component 414 and the reception component 416. In some aspects, the sensing component 141 may direct the transmitter component 414 to transmit radar signals with a pre-defined waveform (e.g., frequency-modulated continuous-wave (FMCW) radar, pulse radar, etc.) and receive reflected signals corresponding to the radar signals via the reception component 416. In addition, the sensing component 141 may perform radar signal processing using the radar signals and the reflected signals, e.g., the sensing component 141 may correlate the reflected signals to the originally-transmitted radar signals. Further, the processing information may be used to make a sensing determination. For instance, the sensing component 141 may apply machine learning techniques to the processing information to classify an event or an object, or predict an outcome. In some aspects, the sensing component 141 may be used to generate an image of an environment, determine high resolution localization information, aid communication by facilitating accurate beam tracking, or detect human activity (e.g., gestures, health activity, etc.).

The measurement component 143 may be configured to determine measurements for performing interference management within the system 400. As an example, the measurement component 143 may be configured to determine signal strength measurements at the base station 602. In some aspects, the measurement component 143 may be configured to determine RSSI information of adjacent UEs (the plurality of UEs 406(1)-(N)). In addition, the measurement component 143 may be configured to determine an amount of interference caused by an wireless sensing activity performed by another device. In some aspects, the measurement component 143 may provide measurements to the interference management component 199 or other devices as measurement information 426 in order implement interference management.

In one configuration, the base station 602 for wireless communication includes means for establishing a connection with a user equipment UE via RAT, determining sensing information for a wireless sensing event to be performed by the UE via the RAT, the sensing information to be used for power control of the UE during the wireless sensing event, and sending the sensing information to the UE. In another configuration, the base station 602 for wireless communication includes means for performing, via a transmitter, a first wireless sensing event, receiving interference information from one or more adjacent wireless devices connected to a RAN, the interference information including interference measurements captured by the one or more adjacent wireless devices in response to the first wireless sensing event, determining a power level based on the interference information, the power level decreasing interference at the one or more adjacent wireless devices, and performing, via the transmitter at the power level, a second wireless sensing event. The aforementioned means may be one or more of the aforementioned components of the base station 602 and/or the processing system 614 of the base station 602 configured to perform the functions recited by the aforementioned means. As described supra, the processing system 614 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

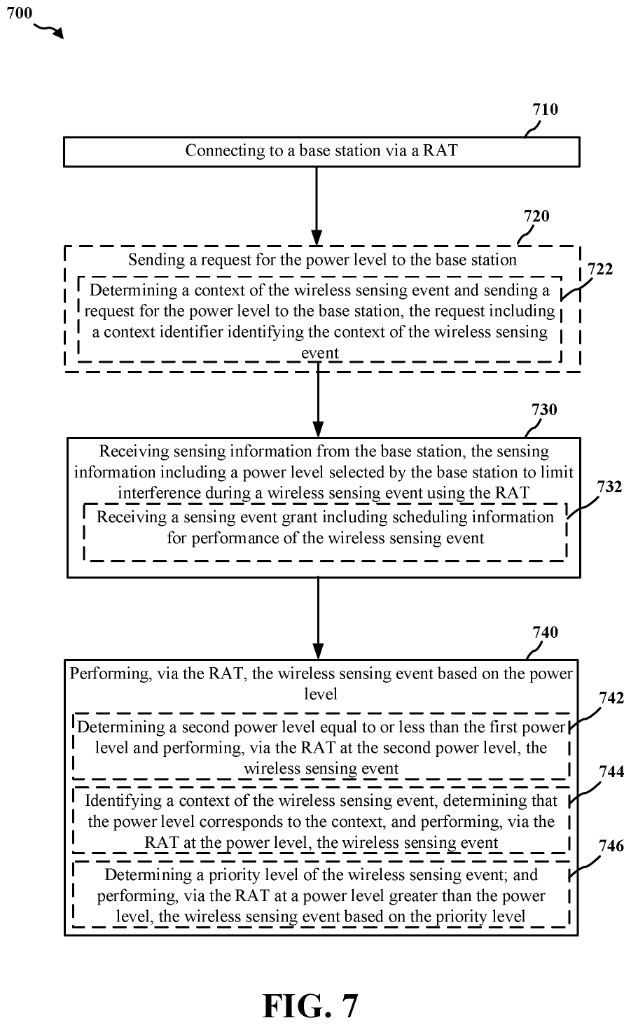

FIG. 7 is a flowchart 700 of a method of power control for wireless sensing.

The method may be performed by a UE (e.g., the UE 104, which may include the memory 360 and which may be the entire UE 104 or a component of the UE 104, such as sensing management component 140, the TX processor 368, the RX processor 356, and/or the controller/processor 359; the UE 502).

At block 710, the method 700 may include connecting to a base station via a

RAT. For example, the UE 402 may connect to the base station 404. In some aspects, the base station 404 may include a serving cell of the UE 402. Further, the base station 404 may provide wireless service operating in 5G NR or THz spectrum. Accordingly, the UE 104, the TX processor 368, the RX processor 356, and/or the controller/processor 359 may provide means for connecting to a base station via a RAT.

At block 720, the method 700 may optionally include sending a request for the power level to the base station. For example, the configuration component 142 may send the sensing request 424 to the base station 404. In some aspects, the sensing request 424 may include at least one of the following a request for a power level for a wireless sensing activity, a proposed power level for the wireless sensing activity, or a context identifier identifying an application of the wireless sensing activity 418. Accordingly, the UE 104, the TX processor 368, the RX processor 356, and/or the controller/processor 359 executing the configuration component 142 may provide means for sending a request for the power level to the base station.

At sub-block 722, the block 720 may include determining a context of the wireless sensing event and sending a request for the power level to the base station, the request including a context identifier identifying the context of the wireless sensing event. For example, the configuration component 142 may determine that the wireless sensing activity 418 is being used in a particular type of application (e.g., a room scale sensing context, a short range sensing context, or a user activity context), and send an identifier of the particular type of application within the sensing request 424.

At block 730, the method 700 may include receiving sensing information from the base station, the sensing information including a power level selected by the base station to limit interference during a wireless sensing event using the RAT. For example, the configuration component 142 may receive the sensing information 422 from the base station 404. In some aspects, the sensing information 422 may be received in a service communication or an RRC communication. Accordingly, the UE 104, the RX processor 356, and/or the controller/processor 359 executing the configuration component 142 may provide means for receiving sensing information from the base station, the sensing information including a power level selected by the base station to limit interference during a wireless sensing event using the RAT.

At sub-block 732, the block 730 may optionally include receiving a sensing event grant including resource information for performance of the wireless sensing event. For instance, in some aspects, the sensing request 424 may indicate a request to perform the wireless sensing activity 418. In response, the sensing information 422 may include a sensing grant indicating a power level or scheduling resource for performing the wireless sensing activity 418.

At block 740, the method 700 may include performing, via the RAT, the wireless sensing event based on the power level. For example, the configuration component 142 configure the sensing component 141 based on the sensing information 422, and the sensing component 141 may perform the wireless sensing activity 418 using the RAT. In some aspects, the wireless sensing activity 418 may include generating an image of an environment, determining high resolution localization information, facilitating accurate beam tracking, or detecting human activity (e.g., gestures, health monitoring, etc.). Accordingly, the UE 104, the TX processor 368, the RX processor 356, and/or the controller/processor 359 executing the sensing component 141 may provide means for performing, via the RAT, the wireless sensing event based on the power level.

At sub-block 742, the block 740 may optionally include determining a second power level equal to or less than the first power level and performing, via the RAT at the second power level the wireless sensing event. For example, in some examples, the sensing information 422 may include a maximum power level, and the configuration component 142 may configure the sensing component 141 to perform the wireless sensing activity 418 at a power level lesser than or equal than the maximum power level. In addition, the sensing component 141 may perform the wireless sensing activity 418 via the transmitter component 410 at the configured power level using the RAT.

At sub-block 744, the block 740 may optionally include identifying a context of the wireless sensing event, determining that the power level corresponds to the context, and performing, via the RAT at the power level, the wireless sensing event. For example, in some aspects, the sensing information 422 may include a plurality of power levels each corresponding to a particular context. Further, the configuration component 142 may determine a context of the wireless sensing activity 418, identify the power level corresponding to the determined context, and configure the sensing component 141 to perform the wireless sensing activity 418 at the identified power level. In addition, the sensing component 141 may perform the wireless sensing activity 418 via the transmitter component 410 at the identified power level using the RAT.

At sub-block 746, the block 740 may optionally include determining a priority level of the wireless sensing event; and performing, via the RAT at a power level greater than the power level, the wireless sensing event based on the priority level. For example, in some aspects, the sensing information 422 may include a maximum power level for standard priority events. Further, the configuration component 142 may determine a context of the wireless sensing activity 418. In addition, the configuration component 142 may configure the sensing component 141 to perform the wireless sensing activity 418 at a power level equal to or less than the maximum value when the wireless sensing activity is a standard priority application, and configure the sensing component 141 to perform the wireless sensing activity 418 at a power level higher than the maximum value when the wireless sensing activity is high priority application. As an example, if the wireless sensing activity 418 is associated with a health monitoring function or vehicle collision detection, the wireless sensing activity 418 may have a high priority. As such, the configuration component 142 may perform the wireless sensing activity 418 at a power level higher than the maximum value. In addition, the sensing component 141 may perform the wireless sensing activity 418 via the transmitter component 410 at the configured power level using the RAT.

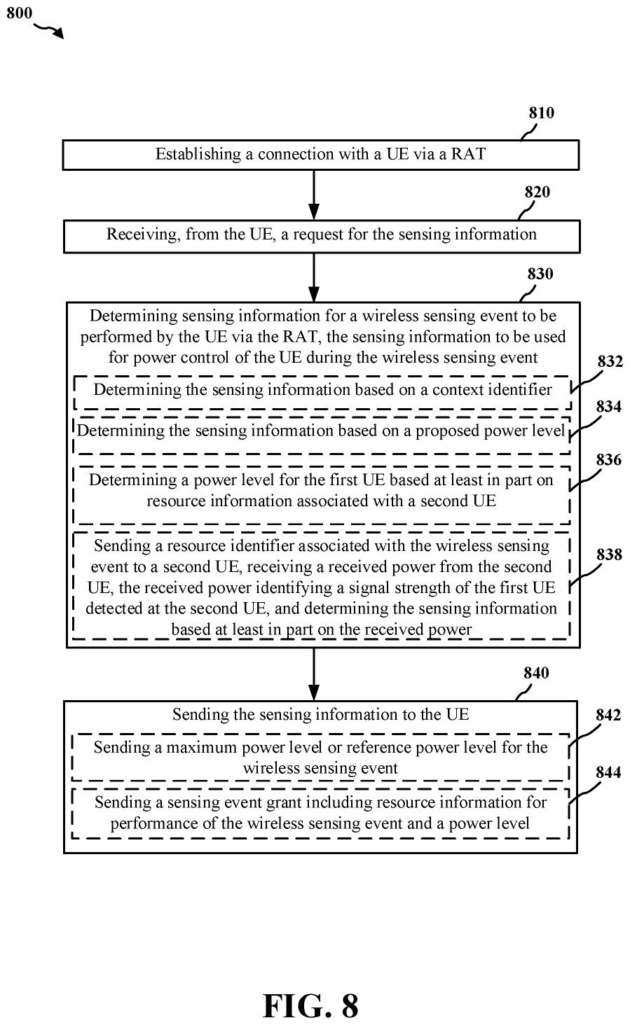

FIG. 8 is a flowchart 800 of a method of power control for wireless sensing.

The method may be performed by a base station (e.g., the base station 102, which may include the memory 376 and which may be the entire base station or a component of the base station, such as sensing management component 198, the TX processor 316, the RX processor 370, and/or the controller/processor 375; the base station 602).

At block 810, the method 800 may include establishing a connection with a UE via a RAT. For example, the base station 404 may provide wireless service to the UE 402. In some aspects, the base station 404 may provide wireless service operating in 5G NR or THz spectrum. Accordingly, the base station 102, the TX processor 316, the RX processor 370, and/or the controller/processor 375 may provide means for establishing a connection with a UE via a RAT.

At block 820, the method 800 may optionally include receiving, from the UE, a request for the sensing information. For example, the interference management component 199 may receive the sensing request 424 from the UE 402. Accordingly, the base station 102, the RX processor 370, and/or the controller/processor 375 executing the interference management component 199 may provide means for receiving, from the UE, a request for the sensing information.

At block 830, the method 800 may include determining sensing information for a wireless sensing event to be performed by the UE via the RAT, the sensing information to be used for power control of the UE during the wireless sensing event. For example, the interference management component 199 may determine the sensing information 422 for performance of the wireless sensing activity 418(1) by the UE 402. Accordingly, the base station 102, the RX processor 370, and/or the controller/processor 375 executing the interference management component 199 may provide means for determining sensing information for a wireless sensing event to be performed by the UE via the RAT, the sensing information to be used for power control of the UE during the wireless sensing event.

At sub-block 832, the block 830 may optionally include determining the sensing information based on a context identifier. For example, the sensing request 424 may include a context identifier indicating an application of the wireless sensing activity 418(1). Further, the interference management component 199 may determine an appropriate power value for the application. As an example, the interference management component 199 may determine that a first power level should be used for room scale sensing, a second power level should be used for a short range sensing, and a third power level should be used for a user health application. In some other example, each context may be associated with a range. For instance, the interference management component 199 may determine that a power level between 0.5 dBm and 5 dBm should be used for user health monitoring, a power level between of 2 dBm-10 dBm should be used for short range sensing, and a power level 5 dBm and 15 dBm should be used for room scale sensing.

At sub-block 834, the block 830 may optionally include determining the sensing information based on the proposed power level. For example, the sensing request 424 may include a proposed power level for performance of the wireless sensing activity 418(1). Further, the interference management component 199 may determine whether the proposed power level will cause an unsuitable level of interference 420 at least one of the UEs 406(1)-(N) or the base stations 408(1)-(N). In some aspects, the interference management component 199 may determine whether the proposed power level will cause an unsuitable level of interference 420 based upon resources allocated for the communication operations 428(1)-(N). Additionally, or alternatively, the interference management component 199 may determine whether the proposed power level will cause an unsuitable level of interference 420 based upon the proximity of the UE 402 to at least one of the UEs 406(1)-(N) or the base stations 408(1)-(N), or the signal strength (e.g., RSSI) of the UE 402 previously detected at least one of the UEs 406(1)-(N) or the base stations 408(1)-(N).

At sub-block 836, the block 830 may optionally include determining a power level for the first UE based at least in part on resource information associated with a second UE. For example, the interference management component 199 may determine a power level for performing the wireless sensing activity 418(1) based at least in part on resources allocated to the UE 406 for an communication operation 428(1) (e.g., a UL communication operation). In some aspects, the interference management component 199 may determine a power level for the wireless sensing activity 418(1) that may cause interference at the UE 406(1) below a threshold during a particular time associated with resources allocated to the UE 406(1). Additionally, the interference management component 199 may determine a period of time for performing the wireless sensing activity 418(1) based at least in part on identifying when one or more resources associated with performing wireless sensing activity 418(1) are not allocated to the UE 406(1).

At sub-block 838, the block 830 may optionally include sending a resource identifier associated with the wireless sensing event to a second UE, receiving a received power from the second UE, the received power identifying a signal strength of the first UE detected at the second UE, and determining the sensing information based at least in part on the received power. For example, the interference management component 199 may send the UE 406(1) a resource identifier identifying at least a frequency band or timing information. In response, the UE 406(1) may determine measurement information 426 identifying a received power (e.g., RSSI) associated with use of the identified resource by the UE 402, and send the measurement information 426 to the base station 404. Further, the base station 404 may employ the received power to determine the sensing information 422. In some aspects, the base station 402 may determine the power level based on comparing an expected value to the received power detected by the UE 406(1) when monitoring the identified resource. In some examples, the base station may 402 determine that the power level of the transmitter component 410 needs to be decreased given the received power detected at the UE 406(1) based on the resource identifier.

At block 840, the method 800 may include sending the sensing information to the UE. For example, the interference management component 199 may send the sensing information 422 to the UE 402. Accordingly, the base station 102, the TX processor 370, and/or the controller/processor 375 executing the interference management component 199 may provide means for sending the sensing information to the UE.

At sub-block 842, the block 840 may optionally include sending a maximum power level or reference power level for the wireless sensing event. For example, the sensing information 422 may include a maximum power level or reference power level for performing the wireless sensing activity 418(1). As such, the interference management component 199 may send the maximum power level or reference power level within the sensing information 422 to the UE 402

At sub-block 844, the block 840 may optionally include sending a sensing event grant including resource information for performance of the wireless sensing event and a power level. For example, the sensing information 422 may include a sensing grant including a power level and resource information for performing the wireless sensing activity 418(1). As such, the interference management component 199 may send the sensing event grant within the sensing information 422 to the UE 402.

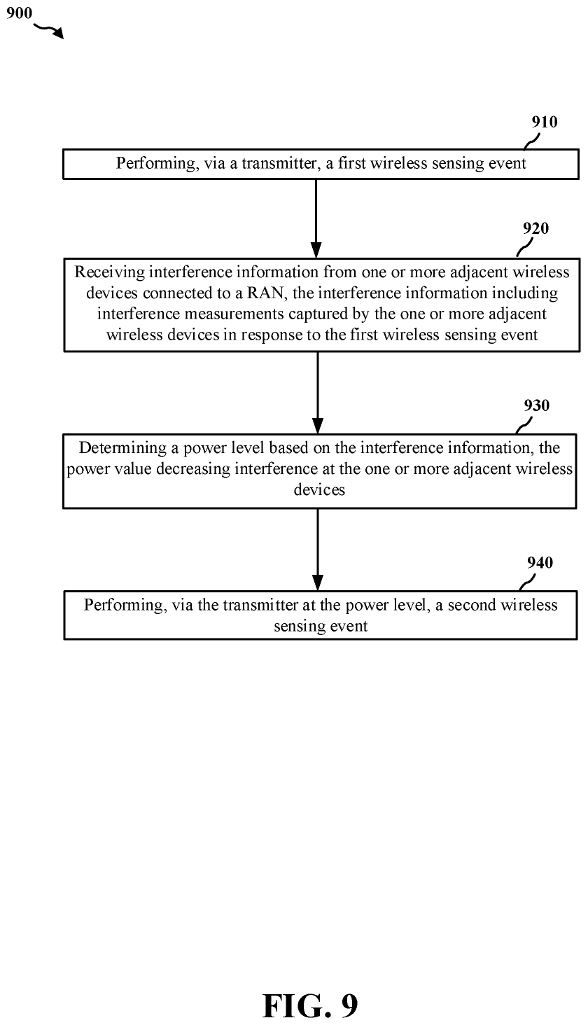

FIG. 9 is a flowchart 900 of a method of power control for wireless sensing.

The method may be performed by a base station (e.g., the base station 102, which may include the memory 376 and which may be the entire base station or a component of the base station, such as sensing management component 198, the TX processor 368, the RX processor 356, and/or the controller/processor 359; the base station 602).

At block 910, the method 900 may include performing, via the transmitter, a first wireless sensing event. For example, the sensing component 141 may perform the wireless sensing event 430(1). Accordingly, the base station 102, the TX processor 316, the RX processor 370, and/or the controller/processor 375 executing the sensing component 141 may provide means for performing, via the transmitter, a first wireless sensing event.

At block 920, the method 900 may include receiving interference information from one or more adjacent wireless devices connected to the RAN, the interference information including interference measurements captured by the one or more adjacent wireless devices in response to the first wireless sensing event. For example, the interference management component 199 may receive the measurement information 426 from the plurality of UEs 406(1)-(N) and the plurality of base stations 408(1)-(N). Further, the measurement information 426 may include interference measurements captured during performance of the wireless sensing activity 430(1) at the plurality of UEs 406(1)-(N) and the plurality of base stations 408(1)-(N). Accordingly, the base station 102, the RX processor 356, and/or the controller/processor 359 executing the interference management component 199 may provide means for receiving interference information from one or more adjacent wireless devices connected to the RAN, the interference information including interference measurements captured by the one or more adjacent wireless devices in response to the first wireless sensing event.

At block 930, the method 900 may include determining a power level based on the interference information, the power value decreasing interference at the one or more adjacent wireless devices. For example, the interference management component 199 may determine a power level based on the measurement information 426. In particular, the interference management component 199 may identify a power level that decreases the interference measurements captured at the plurality of UEs 406(1)-(N) and the plurality of base stations 408(1)-(N) during performance of the wireless sensing activity 430(1). For instance, the base station 408(1) may determine an interference measurement based upon the interference 432, and the interference management component 199 may determine a power level expected to decrease the interference measurement at the base station 408(1), in response to a subsequently performed wireless sensing event 430(2), so that it falls below a threshold. Accordingly, the base station 102, the TX processor 316, the RX processor 370, and/or the controller/processor 375 executing the interference management component 199 may provide means for determining a power level based on the interference information, the power value decreasing interference at the one or more adjacent wireless devices.

At block 940, the method 900 may include performing, via the transmitter at the power level, a second wireless sensing event. For example, the sensing component 141 may perform the wireless sensing activity 330(2) based on the power level. In some examples, the wireless sensing activity 330(2) may be used to determine the location of the UE 402, and the location may be used to establish or adjust the connection between the UE 402 and the base station 404. Accordingly, the base station 102, the TX processor 316, the RX processor 370, and/or the controller/processor 375 executing the sensing component 141 may provide means for performing, via the transmitter at the power level, a second wireless sensing event.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
connecting to a base station via a radio access technology (RAT);
receiving sensing information from the base station, the sensing information including a power level selected by the base station to limit interference during a wireless sensing event using the RAT; and
performing, via the RAT, the wireless sensing event based on the power level.

2. The method of claim 1, wherein the power level is a first power level, and performing the wireless sensing event further comprises:
determining a second power level equal to or less than the first power level; and
performing, via the RAT at the second power level, the wireless sensing event.

3. The method of claim 1, wherein performing the wireless sensing event comprises:
identifying a context of the wireless sensing event;
determining that the power level corresponds to the context; and
performing, via the RAT at the power level, the wireless sensing event.

4. The method of claim 1, wherein the power level is a first power level, and performing the wireless sensing event comprises:
determining a priority level of the wireless sensing event; and
performing the wireless sensing event based on the priority level at a second power level greater than the first power level.

5. The method of claim 1, further comprising sending a request for the power level to the base station, and wherein receiving the sensing information from the base station comprises:
receiving a sensing event grant including resource information for performance of the wireless sensing event.

6. The method of claim 1, further comprising:
determining a context of the wireless sensing event; and
sending a request for the power level to the base station, the request including a context identifier identifying the context of the wireless sensing event.

7. The method of claim 6, wherein sending the request for the power level comprises sending the context identifier identifying at least one of a room scale sensing context, a short range sensing context, or a user activity context.

8. The method of claim 1, wherein the power level is a first power level, further comprising:
sending, to the base station, a request for a sensing grant at a second power level; and
receiving, from the base station based on the second power level, a rejection of the request for the sensing grant.

9. The method of claim 8, further comprising:
receiving, based on the rejection, a third power level from the base station.

10. The method of claim 1, wherein performing the wireless sensing event comprises performing at least one of a room scale sensing, a short range sensing, or a user activity.

11. The method of claim 1, wherein receiving the sensing information comprises receiving a reference power level assigned to uplink communications to the base station.

12. The method of claim 11, further comprising:
determining an actual power level as a percentage of the reference power level; and
performing the wireless sensing event at the actual power level.

13. The method of claim 1, wherein receiving the sensing information from the base station comprises receiving the sensing information in a service traffic communication.

14. The method of claim 1, wherein receiving the sensing information from the base station comprises receiving the sensing information in a Radio Resource Control (RRC) communication.

15. The method of claim 1 wherein the UE is a first UE, the wireless sensing event is a first wireless sensing event, and further comprising:
receive a resource identifier associated with a second wireless sensing event by a second UE;
determining a received power from the second UE based on the resource identifier; and
sending the received power to the base station, the base station using the received power to determine a sensing grant for the second UE.

16. The method of claim 1, wherein the base station is a 5G NR gNB.

17. The method of claim 1, wherein the RAT is a 5G NR RAT or a THz RAT.

18. The method of claim 1, wherein performing the wireless sensing event comprises:
transmitting wideband radar signals with a pre-defined waveform; and
detecting reflected signals corresponding to the wideband radar signals.

19. A user equipment for wireless communication, comprising:
a memory storing computer-executable instructions; and
at least one processor coupled with the memory and configured to execute the computer-executable instructions to:
connect to a base station via a radio access technology (RAT);
receive sensing information from the base station, the sensing information including a power level selected by the base station to limit interference during a wireless sensing event using the RAT; and
perform, via the RAT, the wireless sensing event based on the power level.

20.-21. (canceled)

22. A method of wireless communication at a base station, comprising:
establishing a connection with a user equipment (UE) via a radio access technology (RAT);
determining sensing information for a wireless sensing event to be performed by the UE via the RAT, the sensing information to be used for power control of the UE during the wireless sensing event; and
sending the sensing information to the UE.

23. The method of claim 22, further comprising receiving, from the UE, a request for the sensing information, the request including a context identifier identifying an application for the wireless sensing event, and wherein determining the sensing information comprises determining the sensing information based on the context identifier.

24. The method of claim 22, further comprising receiving, from the UE, a request for the sensing information, the request identifying a proposed power level for the wireless sensing event, and wherein determining the sensing information comprises determining the sensing information based on the proposed power level.

25. The method of claim 22, wherein the UE is a first UE, and determining the sensing information for the wireless sensing event comprises:
determining a power level for the first UE based at least in part on resource information associated with a second UE.

26. The method of claim 22, wherein sending the sensing information to the UE includes sending a maximum power level or reference power level for the wireless sensing event.

27. The method of claim 22, wherein sending the sensing information to the UE includes sending a sensing event grant including resource information for performance of the wireless sensing event and a power level.

28. The method of claim 22, wherein the UE is a first UE, and determining the sensing information for the wireless sensing event comprises:
sending a resource identifier associated with the wireless sensing event to a second UE;
receiving a received power from the second UE, the received power identifying a received signal strength indicator (RSSI) of the first UE detected at the second UE; and
determining the sensing information based at least in part on the received power.

29. The method of claim 22, wherein sending the sensing information to the UE includes sending base station information identifying a plurality of base stations having signals to be measured by the UE when determining a power level for the wireless sensing event.

30. The method of claim 22, wherein the sensing information is first sensing information and the wireless sensing event is a first wireless sensing event, and further comprising:
receiving a request for second sensing information for performing a second wireless sensing event; and
denying performance of the second wireless sensing event based at least in part on an expected interference associated with the second wireless sensing event.

31. The method of claim 22, wherein the wireless sensing event comprises transmitting wideband radar signals with a pre-defined waveform and detecting reflected signals corresponding to the wideband radar signals.

32. A base station for wireless communication, comprising:
a memory storing computer-executable instructions; and
at least one processor coupled with the memory and configured to execute the computer-executable instructions to:
establish a connection with a user equipment (UE) via a radio access technology (RAT);
determine sensing information for a wireless sensing event to be performed by the UE via the RAT, the sensing information to be used for power control of the UE during the wireless sensing event and
send the sensing information to the UE.

33-44. (canceled)
